(19) United States
(12) Patent Application Publication
(10) Pub. No.: US 2024/0407008 A1
(43) Pub. Date: Dec. 5, 2024

(54) RESOURCE ACCESSING METHOD, NETWORK DEVICE, USER EQUIPMENT, AND CHIP

(71) Applicant: GUANGDONG OPPO MOBILE TELECOMMUNICATIONS CORP., LTD., Dongguan (CN)

(72) Inventor: Hao LIN, Neuilly-sur-Seine (FR)

(21) Appl. No.: 18/798,026

(22) Filed: Aug. 8, 2024

Related U.S. Application Data
(63) Continuation of application No. PCT/IB2022/000307, filed on Apr. 7, 2022.

(51) Int. Cl. H04W 74/0833

(52) U.S. Cl. CPC H04W 74/0833

(57) ABSTRACT

A resource accessing method is provided. In the method, one physical random-access channel (PRACH) sequence is detected at a random-access channel occasion (RACH occasion, RO) group. The RO group includes a plurality of ROs, wherein the ROs are resources used for a physical random-access channel (PRACH) transmission with a same PRACH sequence.

### CROSS-REFERENCE TO RELATED APPLICATION

This application is a continuation application of International Application No. PCT/IB2022/000307, filed on Apr. 7, 2022, the disclosure of which is incorporated herein by reference in its entirety.

### BACKGROUND OF THE DISCLOSURE

### 1. Field of the Disclosure

The present disclosure generally relates to resource management, in particular, to a resource accessing method, a network device, a user equipment, and a chip.

### 2. Description of Related Art

In new radio (NR) and non-terrestrial networks (NTN) system, the handover procedure for a user equipment (UE) switching from a source cell to a target cell requires the UE to perform random-access channel (RACH) procedure.

### SUMMARY OF THE DISCLOSURE

Exemplary embodiments of the disclosure provide a resource accessing method, a network device, a user equipment, and a chip.

According to one or more embodiments of the disclosure, a resource accessing method adapted for a network device is provided. The resource accessing method includes, but is not limited to: detecting one physical random-access channel (PRACH) sequence at a (RACH occasion, RO) group. The RO group includes multiple ROs, and the ROs are resources used for a PRACH transmission with a same PRACH sequence.

According to one or more embodiments of the disclosure, a resource accessing method adapted for a user equipment (UE) is provided. The resource accessing method includes, but is not limited to: transmitting one PRACH sequence at a RO group. The RO group includes multiple ROs, and the ROs are resources used for a PRACH transmission with a same PRACH sequence.

According to one or more embodiments of the disclosure, a network device is provided. The network device includes, but is not limited to, a memory, a transceiver, and a processor. The memory is configured to store instructions. The transceiver is configured to transmit or receive signals. The processor is coupled to the memory and the transceiver. The processor is configured to execute the instructions to cause the network device to perform the aforementioned resource accessing method.

According to one or more embodiments of the disclosure, a UE is provided. The UE includes, but is not limited to, a memory, a transceiver, and a processor. The memory is configured to store computer program. The transceiver is configured to transmit or receive signals. The processor is coupled to the memory and the transceiver. The processor is configured to execute the computer program to cause the network device to perform the aforementioned resource accessing method.

According to one or more embodiments of the disclosure, a chip is provided. The chip is used to implement the aforementioned resource accessing method.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a communication system according to some embodiments of the present disclosure.

FIG. 2 is a flowchart of a resource accessing method according to some embodiments.

FIG. 3 is a schematic diagram of random-access channel occasion (RACH occasion, RO) group according to some embodiments of the present disclosure.

FIG. 4 is a schematic diagram of a RO group according to some embodiments of the present disclosure.

FIG. 5 is a schematic diagram of a RO group according to some embodiments of the present disclosure.

FIG. 6 is a schematic diagram of a RO group according to some embodiments of the present disclosure.

FIG. 7 is a schematic diagram of a RO group according to some embodiments of the present disclosure.

FIG. 8 is a schematic diagram of a RO group according to some embodiments of the present disclosure.

FIG. 9 is a schematic diagram of a RO group according to some embodiments of the present disclosure.

FIG. 10 is a schematic diagram of a RO group according to some embodiments of the present disclosure.

FIG. 11 is a schematic diagram of an ordering of ROs according to some embodiments of the present disclosure.

FIG. 12 is a schematic diagram of a RO group according to some embodiments of the present disclosure.

FIG. 13 is a schematic diagram of a RO group with a starting RO according to some embodiments of the present disclosure.

FIG. 14 is a schematic diagram of a RO group with a starting RO according to some embodiments of the present disclosure.

FIG. 15 is a flowchart of a resource accessing method according to some embodiments of the present disclosure.

FIG. 16 is a block diagram of a resource accessing apparatus according to some embodiments of the present disclosure.

FIG. 17 is a block diagram of a resource accessing apparatus according to some embodiments of the present disclosure.

FIG. 18 is a block diagram of a communication device according to some embodiments of the present disclosure.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

Non-terrestrial networks (NTN) refer to networks, or segments of networks, using an airborne or spaceborne vehicle for transmission.

The spaceborne vehicle may be satellites such as low earth orbiting (LEO) satellites, medium earth orbiting (MEO) satellites, geostationary earth orbiting (GEO) satellites as well as highly elliptical orbiting (HEO) satellites.

The airborne vehicle may be high altitude platforms (HAPs) encompassing unmanned aircraft systems (UAS) including lighter than air UAS (LTA), heavier than air UAS (HTA), all operating in altitudes typically, for example, between 8 and 50 km, quasi-stationary.

Communications via satellite may bring the coverage to the locations that normally cellular operators are not willing to deploy either due to non-stable crowd potential clients, e.g. extreme rural, or due to the high deployment cost, e.g. middle of the ocean, mountain peak. Nowadays, satellite communications is a separate technology to 3GPP cellular technology. However, coming to 5G era or further era, these two technologies may merge together. That is a 5G or further generation terminal may access to cellular and satellite networks. NTN can be good candidate technology for this purpose. It is to be designed based on 3GPP NR with the necessary enhancement.

In new radio (NR) and NTN system, the handover procedure for a user equipment (UE) switching from a source cell to a target cell requires the UE to perform random-access channel (RACH) procedure. However, that would increase the handover latency.

It should be noticed that in NTN system, the service coverage is the main issue for ensuring a good quality of service. For example, regarding a satellite with high altitude, e.g. GEO or MEO satellites, the service coverage is very much limited due to the fairly long distance between the UE and the satellite. Furthermore, for a commercial handheld device such as a smartphone, the transmit power is restricted to 23 dBm and the UE antenna gain is relatively smaller than that of a classical satellite device, e.g. the smartphone antenna gain may be below 0 dBi. Therefore, there is a need for increasing the coverage for PRACH transmission and reducing the handover latency.

The technical solutions in the embodiments of the disclosure can be applied to various communication systems, such as global system of mobile communication (GSM) system, code division multiple access (CDMA) system, wideband code division multiple access (WCDMA) system, general packet radio service (GPRS), long term evolution (LTE) system, LTE Frequency division duplex (FDD) system, LTE time division duplex (TDD), universal mobile telecommunication system (UMTS), worldwide interoperability for microwave access (WiMAX) communication system, internet of thing (IoT) system, NTN system, or 5G system, etc.

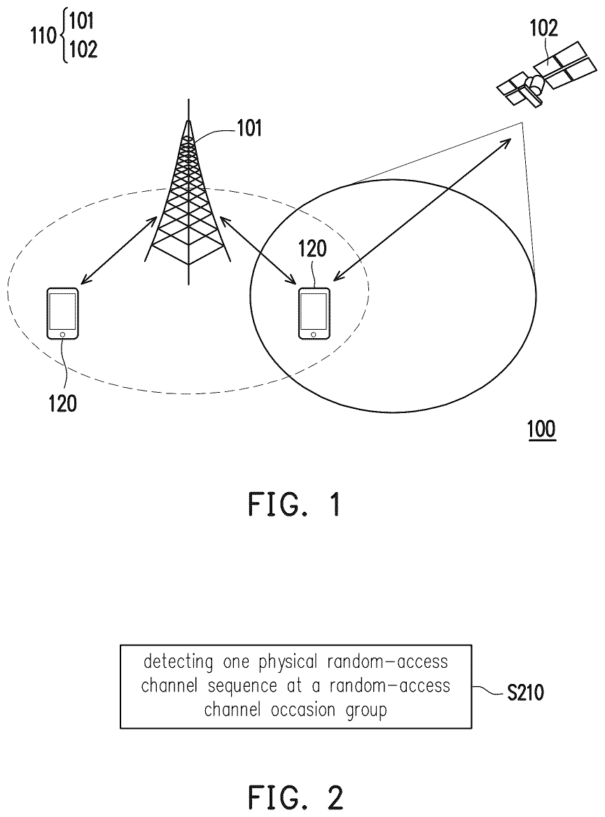

FIG. 1 is a schematic diagram of a communication system 100 according to some embodiments of the present disclosure. Referring to FIG. 1, the communication system 100 may include network devices 110. The network device 110 may be a device that communicates with a user equipment (UE) 120 (or referred to as a mobile terminal or a terminal). The network device 110 may provide communication coverage for a specific geographic area, and may communicate with UEs located in the coverage area.

In some embodiments, the network device 110 may be a base station 101 such as a Base Transceiver Station (BTS) in a GSM system or a CDMA system, a base station (NodeB, NB) in a WCDMA system, an evolved base station (Evolutional Node B, eNB or eNodeB) in an LTE system, a wireless controller in the Cloud Radio Access Network (CRAN), or the network device can be a mobile switching center, a relay station, an access point, a vehicle-mounted equipment, a wearable device, a hub, a switch, a bridge, a router, a network side device in 5G networks, or a network device of a Public Land Mobile Network (PLMN) in future evolution, etc.

In some embodiments, the network device 110 may be a satellite 102 as aforementioned airborne or spaceborne vehicle.

The UE 120 and the satellite are connected in communication through a service link, and the service link refers to a radio link between the UE 120 and the satellite. In addition, the UE 120 may also support a wireless communication connection with a terrestrial access network.

The communication system 100 further includes at least one UE 120 located within the coverage area of the network device 110. As used herein, the UE 120 may be, but is not limited to, connection via wired lines, such as via Public Switched Telephone Networks (PSTN), Digital Subscriber Line (DSL), digital cables, and direct cable connections; and/or another data connection/network; and/or via a wireless interface, such as digital TV networks such as DVB-H networks, satellite networks, AM-FM broadcast transmitter for cellular networks, Wireless Local Area Networks (WLAN); and/or another terminal device that is set to receive/send communication signals; and/or Internet of Things (IoT) device. A UE 120 set to communicate through a wireless interface may be referred to as a “wireless communication terminal”, a “wireless terminal” or a “mobile terminal”. Examples of mobile terminals include, but are not limited to, satellite or cellular phones; Personal Communications System (PCS) terminals that can be combined with cellular radio phones with data processing, fax, and data communication capabilities; can include radio phones, pagers, Internet/intranet PDA with internet access, Web browser, memo pad, calendar, and/or PDA of Global Positioning System (GPS) receiver; as well as conventional laptop and/or palmtop receivers or other electronic devices including radio telephone transceivers. UE can refer to access terminals, terminal device, user units, user stations, mobile stations, mobile platforms, remote stations, remote terminals, mobile equipment, user terminals, terminals, wireless communication equipment, user agents, or user equipment. The access terminal can be a cellular phone, a cordless phone, a Session Initiation Protocol (SIP) phone, a Wireless Local Loop (WLL) station, a Personal Digital Assistant (PDA), handheld devices with wireless communication functions, computing devices, or other processing devices connected to wireless modems, in-vehicle devices, wearable devices, terminal devices in 5G networks, or terminal devices in PLMN in future evolution, etc.

In the NTN technology, the UE 120 may also be referred to as an NTN terminal, and the NTN terminal may be a terminal defined by the third generation partnership project (3GPP). Alternatively, when the satellite does not directly serve the terminal defined by the 3GPP, the NTN terminal may be a terminal for a specific satellite system.

In some embodiments, the 5G system or 5G network may also be referred to as a New Radio (NR) system or an NR network.

In some embodiments, the communication system 100 may further include other network entities such as a network controller and a mobile management entity, the disclosure provides no limitation thereto.

It should be understood that a device with a communication function in the network/system in the embodiment of the disclosure may be referred to as a communication device. Taking the communication system 100 shown in FIG. 1 as an example, the communication device may include a network device 110 and a UE 120 with a communication function. The network device 110 and the UE 120 may be the specific devices described above, and no further description is incorporated herein. The communication device may also include other devices in the communication system 100, such as network controllers, mobile management entities, and other network entities, the disclosure provides no limitation thereto.

It should be understood that the terms “system” and “network” used in the disclosure are often used interchangeably. The term “and/or” in the disclosure is only an association relationship describing the associated objects, which means that there can be three kinds of relationships, for example, A and/or B, which can mean three situations: A is present alone, A and B are present simultaneously, or B is present alone. In addition, the character “/” in the disclosure generally indicates that the associated objects are in an “or” relationship.

To facilitate understanding of the technical solutions of the embodiments of the disclosure, the technical concepts related to the embodiments of the disclosure are described below.

FIG. 2 is a flowchart of a resource accessing method according to some embodiments of the present disclosure. Referring to FIG. 2, a network device detects one physical random-access channel (PRACH) sequence at a random-access channel occasion (RACH occasion, RO) group (step S210).

Specifically, the RO group includes one or more ROs. The ROs are (radio) resources used for a PRACH transmission with a same PRACH sequence. It should be noticed that in legacy system, a UE may select merely one RO for PRACH transmission. For one of the objectives (such as PRACH coverage enhancement), a UE may transmit a PRACH transmission over more than one RO. These ROs would be set as a RO group. The UE may select a RO group and transmit the PRACH transmission over the selected RO group.

On the other hand, PRACH sequence (or referred to as preamble sequence or random access preamble) is used for one or more UEs on resource contention in a random access procedure. A network device may inform one or more UEs to trigger random access with a defined PRACH sequence. Alternatively, a UE may select a PRACH sequence for triggering random access by itself.

In some embodiments, merely one PRACH sequence would be used on multiple ROs of a RO group for a PRACH transmission. That is the UE may transmit the same PRACH sequence over one or more ROs of the same RO group.

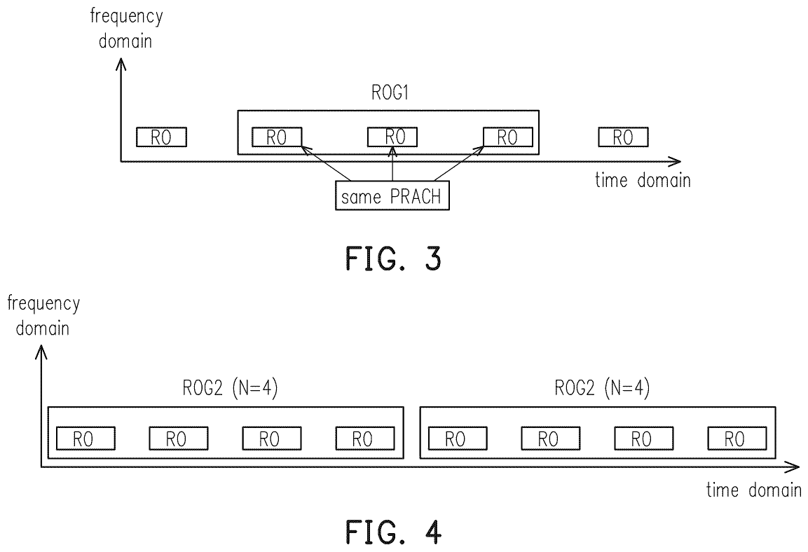

For example, FIG. 3 is a schematic diagram of a RO group ROG1 according to some embodiments of the present disclosure. Referring to FIG. 3, there is a first parameter, e.g. N, that configures the number of ROs within a RO group ROG1. For example, if the N equals 4 in FIG. 3, it means that a RO group ROG1 contains 4 ROs. In other words, the RO group ROG1 is composed of a set of 4 ROs. The UE may transmit the same PRACH sequence in these 4 ROs, which is equal to a PRACH repetition transmission with the repetition number being 4. Furthermore, in some embodiments, the configuration of ROs may follow the legacy RO configuration, where the ROs are configured to be periodic.

In some embodiments, the network device detects the PRACH sequence over the RO group. The receiver of the network device may combine one or more ROs of the same RO group for the PRACH detection. Taking FIG. 3 as an example, PRACH repetition transmission with repetition number as 4 is performed. On the network side, the receiver may combine these 4 ROs for the PRACH detection, yielding a better detection performance. Therefore, the PRACH transmission coverage may be increased.

In some embodiments, the network device may determine or configure the RO group, and transmit a configuration message indicating the RO group to one or more UEs. The RO group may be pre-defined. Alternatively, the RO group may be determined based on resource conditions or a pre-defined rule.

In some embodiments, the configuration message includes the first parameter (i.e., the number of ROs in a RO group).

In some embodiments, the first parameter is configured by the network device or pre-defined.

In some embodiments, when the first parameter is configured by the network device, the first parameter is configured in system information and/or a dedicated radio resource control (RRC) message. The dedicated RRC message may be merely transmitted to one UE. However, the system information may be broadcast to more than one UE.

There may be various arrangements of RO group.

In some embodiments, multiple ROs includes a first RO and a second RO, and the first RO and the second RO are overlapped in the frequency domain. That is, the network device selects the first and second ROs having the same whole or part of frequency resource in the frequency domain as the same RO group. However, the first and second ROs occupy different time resources in the time domain. It should be noticed that there may be more ROs occupying the same whole or part of frequency resource in the same RO group.

For example, FIG. 4 is a schematic diagram of a RO group ROG2 according to some embodiments of the present disclosure. Referring to FIG. 4, these 4 ROs can be 4 ROs occupying different time resources in the time domain. These 4 ROs are set as the same RO group ROG2.

In some embodiments, multiple RO includes a third RO and a fourth RO, and the third RO and the fourth RO are overlapped in the time domain. That is, the network device selects the third and fourth ROs having the same whole or part of time resource in the time domain as the same RO group. However, the third and fourth ROs occupy different frequency resources in the frequency domain. It should be noticed that there may be more ROs occupying the same whole or part of time resource in the same RO group.

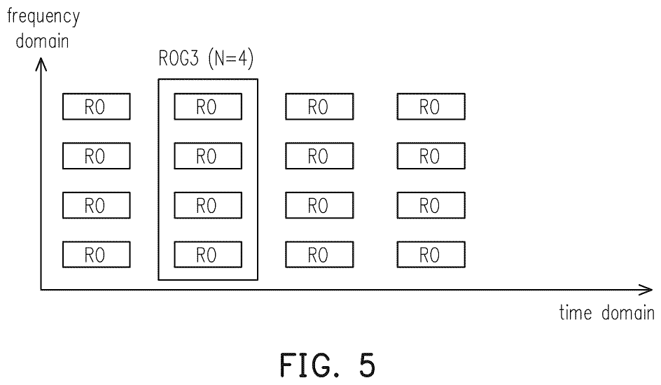

For example, FIG. 5 is a schematic diagram of a RO group ROG3 according to some embodiments of the present disclosure. Referring to FIG. 5, these 4 ROs can be 4 ROs occupying different frequency resources in the frequency domain. These 4 ROs are set as the same RO group ROG3.

In some embodiments, multiple ROs are overlapped in time domain or frequency domain. That is, the network device selects these ROs having the same whole or part of time resource in the time domain or having the same whole or part of frequency resource in the frequency domain as the same RO group.

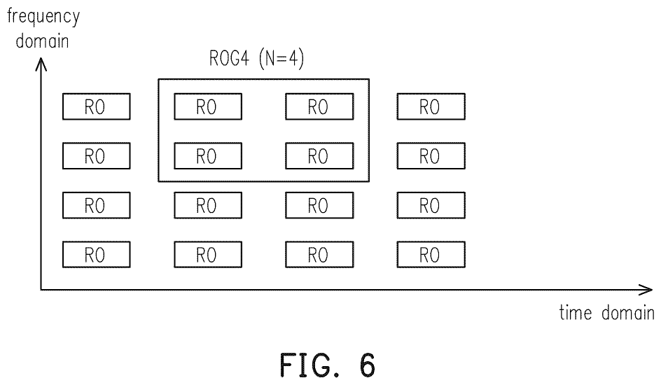

For example, FIG. 6 is a schematic diagram of a RO group ROG4 according to some embodiments of the present disclosure. Referring to FIG. 6, in the RO group ROG 4, each RO has a neighboring RO occupying the same time resource and another neighboring RO occupying the same frequency resource.

In some embodiments, regarding the RO grouping in the time domain such as the embodiment of FIG. 4 or FIG. 6, two or more ROs of the same RO group are consecutive without another RO therein in the time domain of radio resources. There is no other RO located between two ROs of the same RO group. Therefore, the RO group contains consecutive ROs in the time domain.

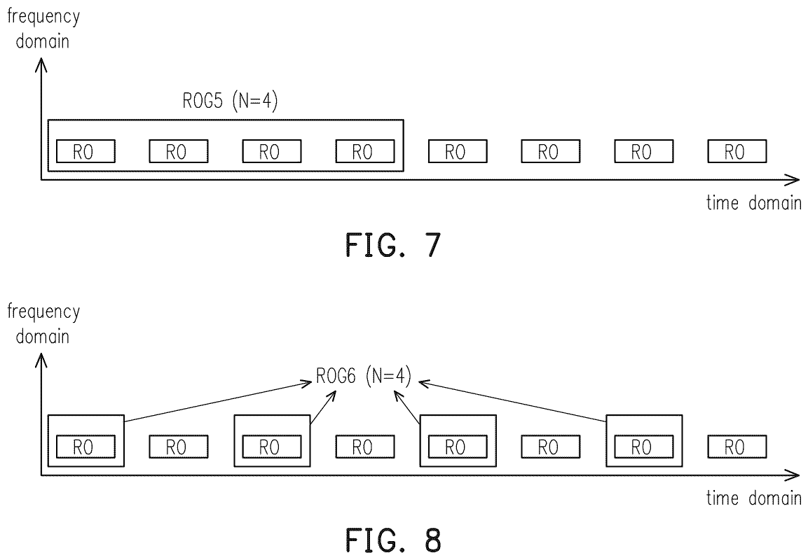

For example, FIG. 7 is a schematic diagram of a RO group ROG5 according to some embodiments of the present disclosure. Referring to FIG. 7, 4 consecutive ROs in the time domain form a RO group ROG5.

In some embodiments, regarding the RO grouping in the time domain such as the embodiment of FIG. 4 or FIG. 6, another RO is located between two ROs of the same RO group in the time domain of radio resources. The RO group contains non-consecutive ROs in the time domain. It should be noticed that another RO located between two ROs of the same RO group may belong to another RO group or may not belong to any RO group, e.g., the RO group of another RO is absent.

For example, FIG. 8 is a schematic diagram of a RO group ROG6 according to some embodiments of the present disclosure. Referring to FIG. 8, non-consecutive ROs are grouped in a RO group ROG6. In the RO group ROG6, when the network device selects one RO for the RO group ROG6, another RO next to the selected RO in the time domain would be skipped for the same RO group. The network device may select a RO next to the skipped RO in the time domain for the RO group ROG6. It should be noticed that more ROs may be skipped in other embodiments.

In some embodiments, regarding the RO grouping in the frequency domain such as the embodiment of FIG. 5 or FIG. 6, two or more ROs of the same RO group are consecutive without another RO therein in the frequency domain of radio resources. There is no other RO located between two ROs of the same RO group. Therefore, the RO group contains consecutive ROs in the frequency domain.

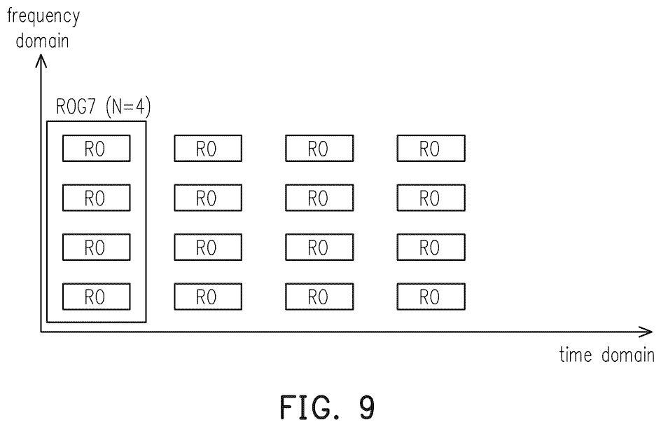

For example, FIG. 9 is a schematic diagram of a RO group ROG7 according to some embodiments of the present disclosure. Referring to FIG. 9, 4 consecutive ROs in the frequency domain form a RO group ROG7.

In some embodiments, regarding the RO grouping in the frequency domain such as the embodiment of FIG. 5 or FIG. 6, another RO is located between two of multiple ROs in the frequency domain of radio resources. The RO group contains non-consecutive ROs in the frequency domain. It should be noticed that another RO located between two ROs of the same RO group may belong to another RO group or may not belong to any RO group, e.g., the RO group of another RO is absent.

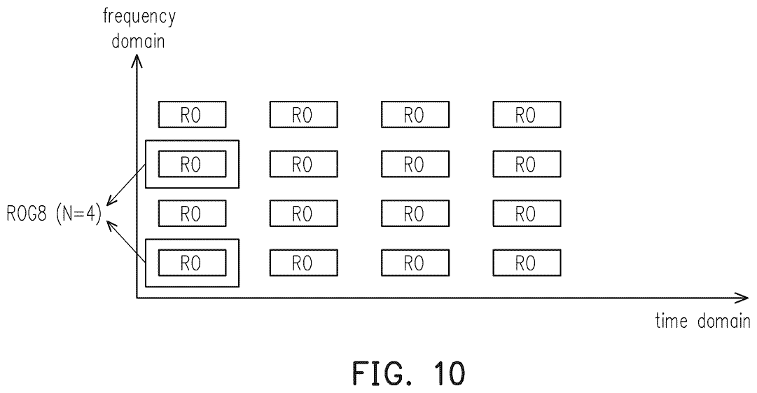

For example, FIG. 10 is a schematic diagram of a RO group ROG8 according to some embodiments of the present disclosure. Referring to FIG. 10, non-consecutive ROs are grouped in a RO group ROG8. In the RO group ROG8, when the network device selects one RO for the RO group ROG8, another RO next to the selected RO in the frequency domain would be skipped for the same RO group. The network device may select a RO next to the skipped RO in the frequency domain for the RO group ROG8. It should be noticed that more ROs may be skipped in other embodiments.

In some embodiments, the network device may determine an ordering of multiple configured ROs. There may be more than one configured RO could be selected for a RO group. To distinguish multiple configured ROs, an ordering of these configured ROs would be determined.

In some embodiments, the ordering of the configured ROs is determined according to a pre-defined rule.

In some embodiments, the pre-defined rule is that a RO with a lower frequency resource or lower time resource is numbered lower ordering and a RO with a higher frequency resource or higher time resource is numbered higher ordering. The term “lower time resource” is a previous time resource, and the term “higher time resource” is a subsequent time resource. Furthermore, the ordering of the configured ROs with the same resource in the time domain is consecutive. In other words, the ordering may be determined as frequency first and time second, i.e. for the ROs overlap over the same time resource, the RO order is from the lower frequency to higher frequency, then the RO order moves to the subsequent ROs in the time domain.

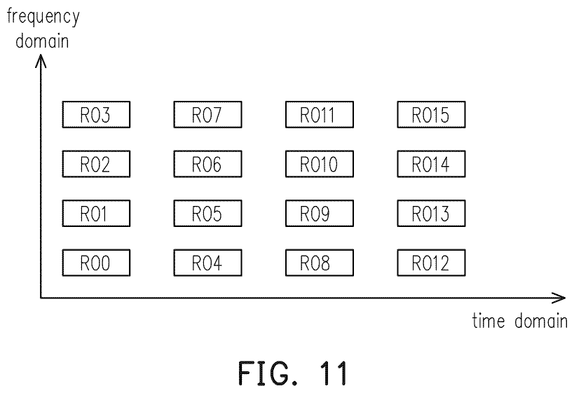

For example, FIG. 11 is a schematic diagram of an ordering of ROs according to some embodiments of the present disclosure. Referring to FIG. 11, “RO0” to “RO15” are the numbers of the configured ROs. The RO numbered “RO0” has a lower frequency resource than the RO numbered “RO1”, “RO2” or “RO3” in the frequency domain. The RO numbered “RO0” has a lower time resource than the RO numbered “RO4”, “RO8” or “RO12” in the time domain. On the other hand, the RO numbered “RO15” has a higher frequency resource than the RO numbered “RO12”, “RO13” or “RO14” in the frequency domain. The RO numbered “RO15” has a higher time resource than the RO numbered “RO3”, “RO7” or “RO11” in the time domain. The ordering would be started from the leftist column of the ROs in the drawing. The RO order is determined from the lower frequency to the higher frequency, for example, from “RO0” to “RO3”. Then, the RO order moves to the next column. Also, the RO order is determined from the lower frequency to the higher frequency, for example, from “RO4” to “RO7”. The rest may be deduced by analogy.

In some embodiments, the network device may group the ROs by following the ordering of the configured ROs. Taking FIG. 11 as an example, the network device may configure the value of N (i.e., the first parameter) for grouping N ROs in a RO group. For example, N equals 4, the first RO group may contain the ROs numbered “RO0”, “RO1”, “RO2”, and “RO3”, the second RO group may contain the ROs numbered “RO1”, “RO2”, “RO3”, and “RO4”, and so on.

Optionally, the RO group may only group the ROs in the time domain. Taking FIG. 11 as an example, the third RO group contains the ROs numbered “RO1”, “RO5”, “RO9”, and “RO13”, the fourth RO group may contain the ROs numbered “RO2”, “RO6”, “RO10”, and “RO14”, and so on.

In some embodiments, the RO group may contain non-consecutive ROs in the frequency domain and/or in the time domain. There is a second parameter to configure a step size between two RO of the same RO group in the time domain and/or frequency domain. When the step size is equal to 1, the RO group contains consecutive ROs. When the step size is larger than 1, the RO group contains non-consecutive ROs.

In some embodiments, the configuration message includes the second parameter (i.e., the step size in a RO group).

In some embodiments, the second parameter is configured by the network device or pre-defined.

In some embodiments, when the second parameter is configured by the network device, the second parameter is configured in system information and/or a RRC message. The dedicated RRC message may be merely transmitted to one UE. However, the system information may be broadcast to more than one UE.

Taking FIG. 11 as an example, when the step size is 2 and the number of ROs in the RO group (i.e., N) is 2, grouping in the time domain may form a RO group containing ROs numbered “RO0” and “RO8”. When step size is 4 and the number of ROs in the RO group (i.e., N) is 2, grouping in the time domain may form a RO group containing ROs numbered “RO0” and “RO12”. When step size is 1 and the number of ROs in the RO group (i.e., N) is 2, grouping in the time domain may form a RO group containing ROs numbered “RO0” and “RO4”.

In some embodiments, the first parameter (i.e., the number of ROs of a RO group) and/or the second parameter (i.e., the step size of a RO group) would be used for each UE served by the network device or dedicated for one or more specific UEs. In some embodiments, the configuration message is contained in system information in a broadcast manner or radio resource control (RRC) message in a UE dedicated manner. Therefore, the UE may receive the configuration message and determine the RO group based on the configuration message.

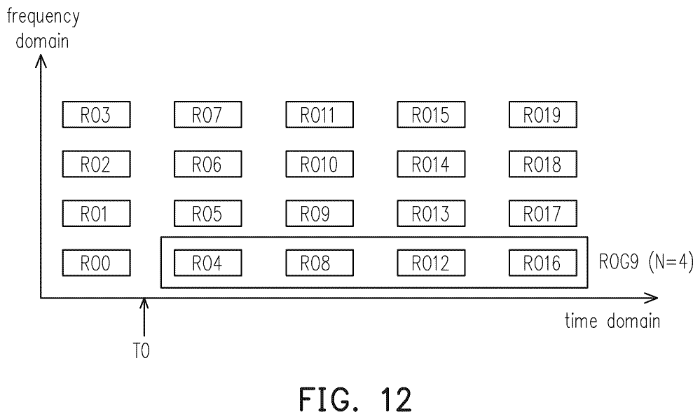

In some embodiments, a UE may determine a starting RO of the RO group. The initial transmission of the PRACH transmission is located at the starting RO. Each configured RO may be a starting RO of a RO group. For example, a UE may select the next RO, relative to a time point when the UE determines a RO group, as a starting RO for a RO group. FIG. 12 is a schematic diagram of a RO group ROG9 according to some embodiments of the present disclosure. Referring to FIG. 12, an idle UE wants to access the network by sending PRACH transmission to the network device. Assumed that the number of ROs in the RO group (i.e., N) is 4 and step size is 1 and grouping ROs in the time domain only, the UE may determine the RO resources at time point TO, then the UE may select the next RO (e.g., the RO numbered “RO4”) as a starting RO and form a RO group ROG9. Alternatively, the UE may select another RO as a starting RO to form a RO group ROG9, such as the RO numbered “RO5” or others. In this embodiment, the network device does not need to or is disabled to configure a specific starting RO. The advantage is that a UE can start transmitting PRACH from any RO, leading to reduced accessing latency.

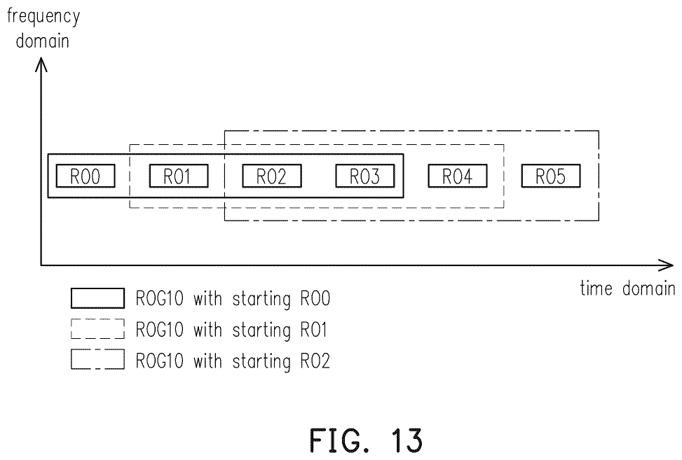

For another example, FIG. 13 is a schematic diagram of a RO group ROG10 with a starting RO according to some embodiments of the present disclosure. Referring to FIG. 13, every RO can be a starting RO. For example, the RO group ROG10 may have a starting RO numbered “RO0”, the RO group ROG10 may have a starting RO numbered “RO1”, or the RO group ROG10 may have a starting RO numbered “RO2”.

In some embodiments, for one of the objectives (such as network detection complexity reduction), the network device may determine a starting RO of the RO group. The initial transmission of the PRACH transmission is located at the starting RO which is designed by the network device. It means that may not every RO can be a starting RO of a RO group. When a UE transmits PRACH transmission to the network device, the UE needs to select a RO group starting with a configured starting RO designed by the network device.

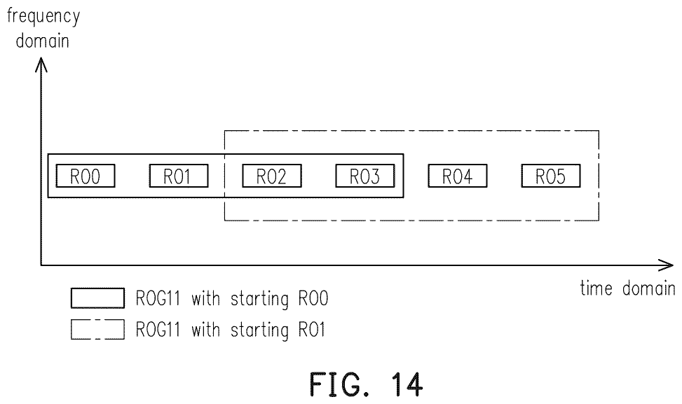

For example, FIG. 14 is a schematic diagram of a RO group ROG11 with a starting RO according to some embodiments of the present disclosure. Referring to FIG. 14, only ROs numbered “RO0” and “RO2” can be the starting RO. Therefore, the UE can only select either a RO group ROG 11 with the RO numbered “RO1” as the starting RO or a RO group ROG11 with the RO numbered “RO2” as the starting RO for PRACH transmission.

In some embodiments, the starting RO may be configured by the network device or may be determined by a pre-defined rule.

In some embodiments, the starting RO is determined according to RO resource position. The RO resource position is the position of the RO in time-frequency resource.

In some embodiments, the RO resource position is referred to a slot index and/or a system frame number (SFN) index in which the RO resource is located. The slot index and the SFN index satisfies a pre-configured relationship. For example, the pre-configured relationship is that any RO having SFN index that is modulo by 4 without reminder could be a starting RO. For another example, the pre-configured relationship is that any RO having slot index that is a even number could be a starting RO. However, the pre-configured relationship could be different based on actual requirements.

In some embodiments, there may be a pre-defined or pre-configured interval between two starting ROs, e.g. the interval is equal to M or the interval is equal to a configured value designated by the network device. The pre-defined or pre-configured interval is a number of ROs between the two starting ROs. For example, the pre-defined or pre-configured interval could be two ROs.

In some embodiments, the configuration message may include a third message. The third message indicates the starting RO.

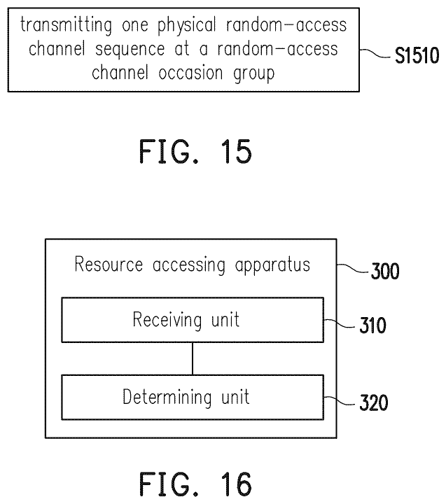

FIG. 15 is a flowchart of a resource accessing method according to some embodiments of the present disclosure. Referring to FIG. 15, a UE transmits one PRACH sequence at a RO group (step S1510). The RO group includes multiple ROs, and the ROs are resources used for one UE with the one PRACH sequence on a PRACH transmission. The detailed description of step S1510 could be referred to FIG. 1 to FIG. 14 and would be omitted.

In some embodiments, merely the PRACH sequence is used on multiple ROs of the RO group.

In some embodiments, the UE may receive a configuration message indicating the RO group and/or determine the RO group based on the configuration message.

In some embodiments, multiple ROs of the same RO group includes a first RO and a second RO. The first RO and the second RO are overlapped in the frequency domain of radio resources. That is grouping ROs in the time domain.

In some embodiments, multiple ROs of the same group includes a third RO and a fourth RO. The third RO and the fourth RO are overlapped in the time domain of radio resources. That is grouping ROs in the frequency domain.

In some embodiments, regarding grouping ROs in the time domain, two ROs of the same RO group are consecutive without another RO therein in the time domain of radio resources.

In some embodiments, regarding grouping ROs in the time domain, another RO is located between two ROs of the same RO group in the time domain of radio resources.

In some embodiments, regarding grouping ROs in the frequency domain, two ROs are consecutive without another RO therein in the frequency domain of radio resources.

In some embodiments, regarding grouping ROs in the frequency domain, another RO is located between two ROs of the same RO group in the frequency domain of radio resources.

In some embodiments, the configuration message includes a first parameter. The first parameter configures the number of ROs in the same group.

In some embodiments, the first parameter is configured by the network device or pre-defined.

In some embodiments, when the first parameter is configured by the network device, the first parameter is configured in system information and/or a dedicated radio resource control (RRC) message.

In some embodiments, the configuration message includes a second parameter. The second parameter configures a step size between two ROs of the same RO group in the time domain and/or frequency domain.

In some embodiments, the second parameter is configured by the network device or pre-defined.

In some embodiments, when the second parameter is configured by the network device, the second parameter is configured in system information and/or a dedicated RRC message.

In some embodiments, the UE may determine an ordering of multiple configured ROs.

In some embodiments, the ordering is determined according to a pre-defined rule.

In some embodiments, the pre-defined rule is that a RO with a lower frequency resource or lower time resource is numbered lower ordering, a RO with a higher frequency resource or higher time resource is numbered higher ordering, and the ordering of the configured ROs with the same resource in time domain is consecutive.

In some embodiments, the UE may determine a starting RO of the RO group. The initial transmission of the PRACH transmission is located at the starting RO.

In some embodiments, the starting RO is configured by the network device or is determined according to a pre-defined rule.

In some embodiments, the starting RO is determined according to RO resource position.

In some embodiments, the RO resource position is referred to a slot index and/or a system frame number (SFN) index in which the RO resource is located, the slot index and the SFN index satisfies a pre-configured relationship.

In some embodiments, there is an pre-defined or pre-configured interval between two starting ROs, the pre-defined or pre-configured interval is a number of ROs between the two starting ROs.

In some embodiments, there is an pre-defined or pre-configured interval between two starting ROs, the pre-defined or pre-configured interval is a number of ROs between the two starting ROs.

The above mainly introduces the solutions of the embodiments of the disclosure from the perspective of the execution process on the method side. It can be understood that, in order to realize the above-mentioned functions, the resource accessing apparatus includes a hardware structure and/or a software module corresponding to each function. Those skilled in the art should easily realize that, in combination with the units, modules and/or algorithm steps of the examples described in the embodiments provided herein, the disclosure can be implemented in the form of hardware or a combination of hardware and computer software. Whether a function is executed by hardware or computer software-driven hardware depends on the specific disclosure and design constraints of the technical solution. Professional technicians can use different methods for each specific disclosure to implement the described functions, but such implementation should not be considered beyond the scope of this disclosure.

The embodiments of the disclosure may divide the functional unit/module of the resource accessing apparatus according to the above method example, for example, each functional unit/module may be divided corresponding to each function, or two or more functions may be integrated into one processing unit/module. The above integrated unit/module may be implemented in the form of hardware or software functional module.

It should be noted that the division of the unit/modules in the embodiments of the disclosure is schematic, and is only a division of logical functions. In actual implementation, there may be another division manner.

FIG. 16 is a block diagram of a resource accessing apparatus 300 according to some embodiments of the present disclosure. Referring to FIG. 16, the resource accessing apparatus 300 may include, but is not limited thereto, a receiving unit 310 and a determining unit 320.

In some embodiments, the receiving unit 310 is configured for detecting one PRACH sequence at a RO group. The RO group includes multiple ROs, and the ROs are resources used for a PRACH transmission with a same PRACH sequence.

In some embodiments, merely the PRACH sequence is used on multiple ROs of the RO group.

In some embodiments, the determining unit 320 is configured for determining the RO group. The resource accessing apparatus 300 may further include a transmitting unit. The transmitting unit is configured for transmitting a configuration message indicating the RO group.

In some embodiments, multiple ROs of the same RO group includes a first RO and a second RO. The first RO and the second RO are overlapped in the frequency domain. That is grouping ROs in the time domain.

In some embodiments, multiple ROs of the same group includes a third RO and a fourth RO. The third RO and the fourth RO are overlapped in the time domain. That is grouping ROs in the frequency domain.

In some embodiments, regarding grouping ROs in the time domain, two ROs of the same RO group are consecutive without another RO therein in the time domain of radio resources.

In some embodiments, regarding grouping ROs in the time domain, another RO is located between two ROs of the same RO group in the time domain of radio resources.

In some embodiments, regarding grouping ROs in the frequency domain, two ROs are consecutive without another RO therein in the frequency domain of radio resources.

In some embodiments, regarding grouping ROs in the frequency domain, another RO is located between two ROs of the same RO group in the frequency domain of radio resources.

In some embodiments, the determining unit 320 is configured for determining a first parameter of the configuration message. The first parameter is the number of ROs in the same group.

In some embodiments, the first parameter is configured by the network device or pre-defined.

In some embodiments, when the first parameter is configured by the network device, the first parameter is configured in system information and/or a dedicated radio resource control (RRC) message.

In some embodiments, the determining unit 320 is configured for determining a second parameter of the configuration message. The second parameter configures a step size between two ROs of the same RO group in the time domain and/or frequency domain.

In some embodiments, the second parameter is configured by the network device or pre-defined.

One embodiment, the when the second parameter is configured by the network device, the second parameter is configured in system information and/or a dedicated RRC message.

In some embodiments, the determining unit 320 is configured for determining an ordering of multiple configured ROs.

In some embodiments, the ordering is determined according to a pre-defined rule.

In some embodiments, the pre-defined rule is that a RO with a lower frequency resource or lower time resource is numbered lower ordering, a RO with a higher frequency resource or higher time resource is numbered higher ordering, and the ordering of the configured ROs with the same resource in time domain is consecutive.

In some embodiments, the determining unit 320 is configured for determining a starting RO of the RO group. The initial transmission of the PRACH transmission is located at the starting RO.

In some embodiments, the starting RO is configured by the network device or is determined according to a pre-defined rule.

In some embodiments, the starting RO is determined according to RO resource position.

In some embodiments, the RO resource position is referred to a slot index and/or a system frame number (SFN) index in which the RO resource is located, and the slot index and the SFN index satisfies a pre-configured relationship.

In some embodiments, there is an pre-defined or pre-configured interval between two starting ROs, the pre-defined or pre-configured interval is a number of ROs between the two starting ROs.

In some embodiments, there is an pre-defined or pre-configured interval between two starting ROs, the pre-defined or pre-configured interval is a number of ROs between the two starting ROs.

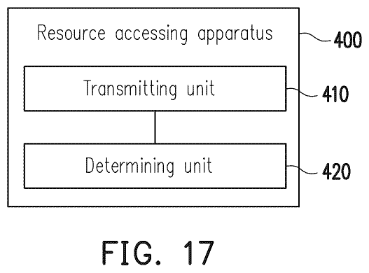

FIG. 17 is a block diagram of a resource accessing apparatus 400 according to some embodiments of the present disclosure. Referring to FIG. 17, the resource accessing apparatus 400 may include, but is not limited thereto, a transmitting unit 410 and a determining unit 420.

In some embodiments, the transmitting unit 410 is configured for transmitting one PRACH sequence at a RO group. The RO group includes multiple ROs, and the ROs are resources used for a PRACH transmission with a same PRACH sequence.

In some embodiments, merely the PRACH sequence is used on multiple ROs of the RO group.

In some embodiments, the resource accessing apparatus 400 may further include a receiving unit (not shown). The receiving unit is configured for receiving a configuration message indicating the RO group. The determining unit 420 is configured for determining the RO group based on the configuration message.

In some embodiments, multiple ROs of the same RO group includes a first RO and a second RO. The first RO and the second RO are overlapped in the frequency domain. That is grouping ROs in the time domain.

In some embodiments, multiple ROs of the same group includes a third RO and a fourth RO. The third RO and the fourth RO are overlapped in the time domain. That is grouping ROs in the frequency domain.

In some embodiments, regarding grouping ROs in the time domain, two ROs of the same RO group are consecutive without another RO therein in the time domain of radio resources.

In some embodiments, regarding grouping ROs in the time domain, another RO is located between two ROs of the same RO group in the time domain of radio resources.

In some embodiments, regarding grouping ROs in the frequency domain, two ROs are consecutive without another RO therein in the frequency domain of radio resources.

In some embodiments, regarding grouping ROs in the frequency domain, another RO is located between two ROs of the same RO group in the frequency domain of radio resources.

In some embodiments, the configuration message includes a first parameter. The first parameter configures the number of ROs in the same group.

In some embodiments, the first parameter is configured by a network device or pre-defined.

In some embodiments, when the first parameter is configured by the network device, the first parameter is configured in system information and/or a dedicated radio resource control (RRC) message.

In some embodiments, the configuration message includes a second parameter. The second parameter configures a step size between two ROs of the same RO group in the time domain and/or frequency domain.

In some embodiments, the second parameter is configured by the network device or pre-defined.

In some embodiments, when the second parameter is configured by the network device, the second parameter is configured in system information and/or a dedicated RRC message.

In some embodiments, the determining unit 420 is configured for determining an ordering of multiple configured ROs.

In some embodiments, the ordering is determined according to a pre-defined rule.

In some embodiments, the pre-defined rule is that a RO with a lower frequency resource or lower time resource is numbered lower ordering, a RO with a higher frequency resource or higher time resource is numbered higher ordering, and the ordering of the configured ROs with the same resource in time domain is consecutive.

In some embodiments, the determining unit 420 is configured for determining a starting RO of the RO group. The initial transmission of the PRACH transmission is located at the starting RO.

In some embodiments, the starting RO is configured by the network device or is determined according to a pre-defined rule.

In some embodiments, the starting RO is determined according to RO resource position.

In some embodiments, the RO resource position is referred to a slot index and/or a SFN index in which the RO resource is located, and the slot index and the SFN index satisfies a pre-configured relationship.

In some embodiments, there is an pre-defined or pre-configured interval between two starting ROs, the pre-defined or pre-configured interval is a number of ROs between the two starting ROs.

In some embodiments, there is an pre-defined or pre-configured interval between two starting ROs, the pre-defined or pre-configured interval is a number of ROs between the two starting ROs.

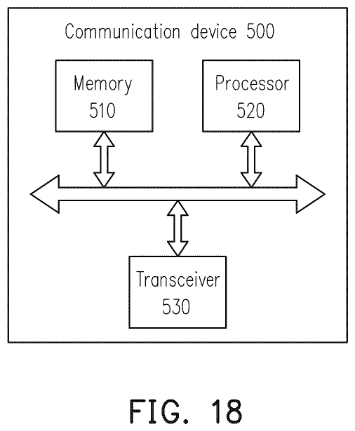

FIG. 18 is a block diagram of a communication device 500 according to some embodiments of the present disclosure. Referring to FIG. 18, the communication device 500 may be a UE or a network device. The communication device 500 may include, but is not limited thereto, a processor 510. The processor 510 can call and run a computer program from a memory to implement the method in the embodiment of the disclosure.

Since the program code stored in the communication device 500 adopts all the technical solutions of all the foregoing embodiments when being executed by the processor 510, it at least has all the advantageous effects brought by all the technical solutions of all the foregoing embodiments, and no further description is incorporated herein.

Optionally, as shown in FIG. 18, the communication device 500 may further include a memory 520. The processor 510 may call and run a computer program from the memory 520 to implement the method in the embodiment of the disclosure.

The memory 520 may be a separate device independent of the processor 510, or may be integrated in the processor 510.

Optionally, as shown in FIG. 18, the communication device 500 may further include a transceiver 530, and the processor 510 may control the transceiver 530 to communicate with other devices. Specifically, the transceiver 530 may send information or data to other devices, or receive information or data sent by other devices.

Specifically, the transceiver 530 may include a transmitter and a receiver. The transceiver 530 may further include an antenna, and the number of antennas may be one or more.

Optionally, the communication device 500 may specifically be a network device in some embodiments of the disclosure, and the communication device 500 may implement the corresponding process implemented by the network device in various methods of the embodiment of the disclosure. For the conciseness, related descriptions are omitted.

Optionally, the communication device 500 may specifically be a mobile terminal, a terminal device, or a UE in some embodiments of the disclosure, and the communication device 500 may implement the corresponding process implemented by the mobile terminal, the terminal device, or the UE in various methods in the embodiment of the disclosure. For conciseness, related description is omitted.

Furthermore, some embodiments of the present disclosure further provide a non-transitory computer-readable storage medium having a program code stored on the non-transitory computer-readable storage medium to cause a computer to perform the resource accessing method described in any one of FIG. 2, FIG. 15, FIG. 16, and FIG. 17.

Since the program code stored in the non-transitory computer-readable storage medium adopts all the technical solutions of all the foregoing embodiments when being executed by the processor, it at least has all the advantageous effects brought by all the technical solutions of all the foregoing embodiments, and no further description is incorporated herein.

It should be noted that, for the foregoing method embodiments, for the sake of simple description, they are all described as a series of action combinations. However, those skilled in the art should know that this disclosure is not limited by the described action order. Because according to the disclosure, certain steps may be performed in another order or simultaneously. Secondly, those skilled in the art should also know that the embodiments described in the specification are all preferred embodiments, and the actions and modules involved are not necessarily required for this disclosure.

In the above embodiments, the description of each embodiment has its own emphasis. For a part that is not described in detail in some embodiments, reference may be made to related descriptions in other embodiments.

In the several embodiments provided in this disclosure, it should be understood that the disclosed device may be implemented in other ways. For example, the device embodiments described above are only schematic. For example, the division of the module is only a logical function division. In actual implementation, there may be another division manner. For example, multiple units, modules or components may be combined or may Integration into another system, or some features can be ignored or not implemented. In addition, the displayed or discussed mutual coupling or direct coupling or communication connection may be indirect coupling or communication connection through some interfaces, devices, units, or modules, and may be electrical or other forms.

The units/modules described as separate components may or may not be physically separated, and the components displayed as modules may or may not be physical units, may be located in one place, or may be distributed on multiple network units. Some or all of the modules may be selected according to actual needs to achieve the objective of the solution of this embodiment.

In addition, each functional unit/module in each embodiment of the disclosure may be integrated into one processing unit/module, or each of the unit/modules may exist separately physically, or two or more unit/modules may be integrated into one unit/module. The above integrated unit/module may be implemented in the form of hardware or in the form of software program unit/modules.

When the integrated unit/module is implemented in the form of a software program unit/module and sold or used as an independent product, it may be stored in a computer-readable memory. Based on such an understanding, the technical solution of the disclosure essentially or part that contributes to the existing technology or all or part of the technical solution can be embodied in the form of a software product, which is stored in a memory, several instructions are included to enable a computer device (which may be a personal computer, a server, or a network device, etc.) to perform all or part of the steps of the method described in the embodiments of the disclosure. The foregoing memory includes a flash disk, a read-only memory (ROM), a random access memory (RAM), a mobile hard disk, a magnetic disk, or an optical disk, and other media that can store program codes.

The embodiments of the disclosure further provide a chip. The chip includes a processor, and the processor can call and run a computer program from the memory to implement the method in the embodiment of the disclosure.

Optionally, the chip may further include a memory. The processor may call and run a computer program from the memory to implement the method in the embodiment of the disclosure.

The memory may be a separate device independent of the processor, or may be integrated in the processor.

Optionally, the chip may further include an input interface. The processor can control the input interface to communicate with other devices or chips, and specifically, can obtain information or data sent by other devices or chips.

Optionally, the chip may further include an output interface. The processor can control the output interface to communicate with other devices or chips, and specifically, can output information or data to other devices or chips.

Optionally, the chip can be applied to the network device in the embodiment of the disclosure, and the chip can implement the corresponding process implemented by the network device in various methods in the embodiment of the disclosure. For conciseness, related details are omitted.

Optionally, the chip can be applied to the UE in the embodiment of the disclosure, and the chip can implement the corresponding process implemented by the UE in various methods in the embodiment of the disclosure. For conciseness, related details are omitted.

It should be understood that the chip mentioned in the embodiment of the disclosure may also be referred to as a system-level chip, a system chip, a chip system, or a system-on-chip, etc.

It should be understood that the memory described above is exemplary but not restrictive. For example, the memory in the embodiment of the disclosure may also be static RAM (SRAM), dynamic RAM (DRAM), synchronous DRAM (SDRAM), double data rate SDRAM (DDR SDRAM), enhanced SDRAM (ESDRAM), synch link DRAM (SLDRAM) and Direct Rambus RAM (DR RAM), etc. That is to say, the memory in the embodiments of the disclosure is intended to include, but is not limited to, these and any other suitable types of memory.

The embodiments of the disclosure further provide a computer program product, including computer program instructions.

Optionally, the computer program product may be applied to the communication device in the embodiment of the disclosure, and the computer program instructions enable the computer to execute the corresponding process implemented by the communication device in various methods of the embodiment of the disclosure. For conciseness, related details are omitted.

The embodiment of the disclosure further provides a computer program.

Optionally, the computer program can be applied to the communication device in the embodiment of the disclosure. When the computer program is run on the computer, the computer can execute the corresponding process implemented by the communication device in various methods of the embodiment of the disclosure. For conciseness, related details are omitted.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A resource accessing method, adapted for a user equipment (UE), the resource accessing method comprising:
transmitting one physical random-access channel (PRACH) sequence at a random-access channel occasion (RACH occasion, RO) group, wherein the RO group comprises a plurality of ROs, the plurality of ROs being resources used for a PRACH transmission with a same PRACH sequence.

2. The resource accessing method according to claim 1, wherein merely the PRACH sequence is used on the plurality of ROs.

3. The resource accessing method according to claim 1, further comprising at least one of following:
receiving a configuration message indicating the RO group; and
determining the RO group.

4. The resource accessing method according to claim 1, wherein the plurality of ROs comprises a first RO and a second RO, wherein the first RO and the second RO are overlapped in frequency domain.

5. The resource accessing method according to claim 4, wherein two of the plurality of ROs are consecutive without another RO therein in the time domain of radio resources.

6. The resource accessing method according to claim 3, wherein the configuration message comprises a second parameter, wherein the second parameter configures a step size between two of the plurality of ROs in at least one of time domain and frequency domain.

7. The resource accessing method according to claim 6, wherein determining the RO group comprises:
determining a starting RO of the RO group, wherein an initial transmission of the PRACH transmission is located at the starting RO, and the starting RO is determined according to RO resource position, wherein the RO resource position is referred to at least one of a slot index and a system frame number (SFN) index in which the RO resource is located, wherein the slot index and the SFN index satisfies a pre-configured relationship.

8. A network device, comprising:
a memory configured to store a computer program;
a transceiver configured to transmit or receive signals; and
a processor coupled to the memory and the transceiver, the processor configured to execute the computer program to cause the network device to perform:
detecting one physical random-access channel (PRACH) sequence at a random-access channel occasion (RACH occasion, RO) group, wherein the RO group comprises a plurality of ROs, the plurality of ROs being resources used for a PRACH transmission with a same PRACH sequence.

9. The network device according to claim 8, wherein merely the PRACH sequence is used on the plurality of ROs.

10. The network device according to claim 8, wherein the processor is configured to execute the computer program to cause the network device to further perform:
determining or configuring the RO group; and
transmitting a configuration message indicating the RO group.

11. The network device according to claim 10, wherein the processor is configured to execute the computer program to cause the network device to perform:
determining a first parameter of the configuration message, wherein the first parameter configures a number of the plurality of ROs.

12. The network device according to claim 11, wherein the first parameter is configured by the network device or pre-defined.

13. The network device according to claim 11, wherein when the first parameter is configured by the network device, the first parameter is configured in at least one of system information and a dedicated radio resource control (RRC) message.

14. The network device according to claim 10, wherein the processor is configured to execute the computer program to cause the network device to perform:
determining a second parameter of the configuration message, wherein the second parameter configures a step size between two of the plurality of ROs in at least one of time domain and frequency domain.

15. A user equipment (UE), comprising:
a memory configured to store a computer program;
a transceiver configured to transmit or receive signals; and
a processor coupled to the memory and the transceiver, the processor configured to execute the computer program to cause the UE to perform:
transmitting one physical random-access channel (PRACH) sequence at a random-access channel occasion (RACH occasion, RO) group, wherein the RO group comprises a plurality of ROs, the plurality of ROs being resources used for a PRACH transmission with a same PRACH sequence.

16. The UE according to claim 15, wherein merely the PRACH sequence is used on the plurality of ROs.

17. The UE according to claim 15, wherein the processor is configured to execute the computer program to cause the UE to further perform at least one of following:
receiving a configuration message indicating the RO group; or
determining the RO group.

18. The UE according to claim 17, wherein the configuration message comprises a first parameter, wherein the first parameter configures a number of the plurality of ROs, and the first parameter is configured by a network device or pre-defined.

19. The UE according to claim 17, wherein when the first parameter is configured by a network device, the first parameter is configured in at least one of system information and a dedicated radio resource control (RRC) message.

20. A chip, comprising: a processor, and configured to call and run a computer program from a memory, so that a device provided with the chip executes the method as claimed in claim 1.
